(19) United States
(12) Patent Application Publication
(10) Pub. No.: US 2015/0257091 A1
(43) Pub. Date: Sep. 10, 2015

(54) Apparatuses, methods and systems for a Wi-Fi Bluetooth multimedia bridge

(71) Applicants: Nissim Zur, Givataim (IL); Eli Arad, Tzofit (IL)

(72) Inventors: Nissim Zur, Givataim (IL); Eli Arad, Tzofit (IL)

(21) Appl. No.: 14/641,511

(22) Filed: Mar. 9, 2015

Related U.S. Application Data
(60) Provisional application No. 61/950,312, filed on Mar. 10, 2014.

(51) Int. Cl. H04W 48/18; H04L 29/08; H04W 4/00

(52) U.S. Cl. CPC H04W 48/18; H04W 4/008; H04L 67/303; H04W 88/06

(57) ABSTRACT

A multimedia communication bridge that includes a long range communication transceiver, a processor, a short range communication transceiver, and a multimedia unit that comprises a speaker and a microphone. The long range communication transceiver is configured to communicate, using a first communication protocol, with a remote server the Internet. The short range communication transceiver is configured to communicate, using a second communication protocol, with multiple local devices. The multimedia communication bridge is configured to receive a message from one of the local devices. The controller is configured to generate a message response request to receive instructions for responding to the message. The long range communication transceiver is configured to transmit the message response request to the remote server and to receive the instructions. The controller is configured to execute the instructions and to respond to the message.

### RELATED APPLICATIONS

This patent application claims priority from U.S. provisional patent 61/950,312 filing date Mar. 10, 2014 which is incorporated herein by reference.

### BACKGROUND OF THE INVENTION

Many innovative new use cases are now being made possible with the introduction of ultra-low power wireless chipsets. Until recently, the only way to achieve data transfer between a sensor and client has been to use wires, or manually collect data from a logging device. Wireless technologies have been available for decades. However, they tend to use significant amounts of power and need specialized equipment to establish communications.

Most target markets are characterized by periodic transfer of small amounts of sensor information between sensor nodes and a central device. Some identified end products that may implement a low power radio system, include cell phones, health and fitness devices, home automation, heating, ventilating, and air conditioning (HVAC), remote controls, gaming, human interface devices (HID), smart meters, payment and many others. These applications are all constrained by the following critical key requirements: ultra-low power, low cost and physical size.

The ultra-low power requirement is mainly due to targeted devices needing to operate for extended periods of time from coin cells or energy scavenger technology. Apart from a low chipset cost having obvious advantages, overall product expense is largely affected by the power source. For example, if a shopping mall has a wireless beacon in every shop and batteries need replacing regularly, the maintenance cost will soon outweigh the advantages of such a technology being deployed.

This description of the background art of Wi-Fi and Bluetooth, analyses the pros and cons of various low power wireless technologies. And lay the foundation information why Wi-Fi Bluetooth Multimedia Bridge (WBMB) device will be needed.

Bluetooth Low Energy

Bluetooth low energy (LE) started life as a project in the Nokia Research Centre with the name Wibree. In 2007, the technology was adopted by the Bluetooth Special Interest Group (SIG) and renamed Bluetooth Ultra-Low Power and then Bluetooth low energy.

The aim of this technology is to enable power sensitive devices to be permanently connected to the Internet. LE sensor devices are typically required to operate for many years without needing a new battery. They commonly use a coin cell, for example the popular CR2032.

LE technology is primarily aimed at mobile telephones, where it is envisaged that a star network topology, similar to Bluetooth, will often be created between the phone and an ecosystem of other devices.

LE may also be known as Bluetooth v4.0 and is part of the public Bluetooth specification. As a result of being a standard, LE benefits from all the advantages of conformance and extensive interoperability testing at unplug fests. A device that operates Bluetooth v4.0 may not necessarily implement other versions of Bluetooth, in such cases it is known as a single mode device. Most new Bluetooth chip sets from leading Bluetooth silicon manufacturers will support Bluetooth and the new LE functionality.

### Is Bluetooth Low Energy Easy to Implement

Based on the amount of software that would be required to implement a simple program and hardware requirements, it's possible to estimate how much effort may be required to implement a simple connectivity application.

LE chipsets come in two categories: single mode and Bluetooth+LE. Single mode configurations are shipped as a single chip that contains the host processor and radio. The protocol stack is integrated in the silicon and exposes some simple Application Programming Interfaces (API) for a developer to work with. As a result, there is little effort required by the developer when creating a new product. Single mode LE devices are often shipped from Silicon vendors as a pre-certified unit. This means Original End Manufacturers (OEM) don't need to spend resources qualifying their new products. If the developer decides to deviate significantly from a given reference design, then it's possible that some features may need retesting.

Dual mode Bluetooth chipsets, as used in a mobile handset, have a host processor present. Silicon endorses normally ship a protocol stack which executes on the host processor and provides a simple API to access Bluetooth and LE. Dual mode Bluetooth chips may also contain their own application processor. Such devices have the sensitive protocol stack burnt into Read Only Memory (ROM) and expose an API as a virtual machine. These types of chips are often found in consumer electronics, like headsets, where more than just sensing applications are necessary.

Power Efficiency

Power efficiency is often queried by customers who are interested in prolonging the battery life of their devices, while still achieving good user experience. For example, when a mobile handset needs to synchronize email, the handset's battery (with a fixed mAh) must last long enough to allow all emails (a fixed quantity) to be downloaded and read by the user. Which wireless technology on the handset would be most efficient? Wi-Fi or Cellular? Similar questions need to be answered for remote sensor devices. The quantity derived is the ‘power per bit’ measurement.

Wi-Fi

Wi-Fi consumes approximately 116 mA at 1.8V when transmitting a 40 Mbps User Datagram Protocol (UDP) payload. Unfortunately, current consumption doesn't reduce when throughput is reduced in a Wi-Fi chipset. Power=116 mA×1.8V=0.210 W, Power per bit=0.210/40,000,000=0.00525 uW/bit

Range

The range of a wireless technology is often thought of as being proportional to the Radio Frequency (RF) sensitivity of a receiver and the power of a transmitter. This is true to some extent. However, there are many other factors that affect the real range of wireless devices. For example, the environment, frequency of carrier, design layout, mechanics and coding schemes. For sensor applications, range can be an important factor. Range is usually stated for an ideal environment, but devices are often used in a congested spectrum and shielded environments. For example, Bluetooth is quoted as a 10 meter technology, but can struggle to provide a reliable Advanced Audio Distribution Profile (A2DP) stream from a pocket to headset, due to cross body shielding. Similar problems can be observed in the health and fitness space, where users have body mounted gadgets and move continuously. It's worth noting that 2.4 GHz is easily attenuated by human bodies.

The following list shows typical ranges that can be expected from ultra-low powered technologies in an open environment: NFC˜5 cm, IrDA˜10 cm, Nike+˜10 m, ANT (+)˜30 m. ZigBee˜100 m, RF4CE based on ZigBee˜100 m, Wi-Fi˜150 m. LE˜100 m

### Peak Power Consumption

Peak power consumption is a critical figure when designing long life low power sensor devices. The main reason for this is that certain types of battery technology are not able to source high currents instantaneously. The common CR2032 coin cell is a popular choice for long life sensor gadgets.

However, it can only source about 15 mA peaks without damage. If the peak current exceeds 15 mA then battery life may be degraded. Demanding 30 mA peaks would reduce realized capacity by about 10% of manufacturers stated figures. Acceptable continuous standard loads are typically 2 mA or less, in order to achieve published capacity figures. Other alternative forms of energy source are available from energy harvesting technologies. Energy harvesters are likely to be used in conjunction with mass deployment ultra-low energy radios, to reduce ongoing maintenance costs of battery replacement. Solar cells are a well-known example of an energy harvester, but they are notorious for low efficiency when converting ambient light into useful electrical energy. An amorphous solar cell of similar dimensions to a CR2032 (3 cm2) would yield 1.5 v×8 uA=12 uW [66]. With such small amounts of power available, it is critical that a radio is selected that doesn't have high current demands.

### SUMMARY OF THE INVENTION

There is provided a Wi-Fi Bluetooth Multimedia Bridge (WBMB) device the belongs to the radio communication technology field, to be specific, relates to bridge different Bluetooth devices over Wi-Fi to internet servers and retrieve contents. The contents can be commanded to WBMB device, or commands to be sent to wireless devices in range of WBMB. Wireless devices can be any Bluetooth Classic, Bluetooth Smart, Bluetooth smart ready or other formats of wireless devices.

WBMB has also multimedia capabilities as inner speaker and microphone. One of its functions is the ability to retrieve multimedia contents, as sound and play it using its inner speaker. Or retrieves, using its inner microphone, a human voice and stream that as a sound to the internet to be recognized by speech recognition. The recognized speech recognition can be used to command wireless devices connected to WBMB device. For example: a Bluetooth Smart light bulb. The user can say “Lights on” and the voice will be recognized on the internet, and the WBMB will send a Bluetooth Smart command to close the light of the Bluetooth Smart light bulb.

In some embodiments of WBMB it utilizes its inner programmable IR remote control in a way it can allow detect or send IR command to a Infra-Red enabling devices.

In more embodiments of WBMB it exposes a web site which enables any user smart phone or internet accesses to see and control all its connected wireless devices to WBMB device.

In more embodiments of WBMB it exposes a USB port where the user can plug USB devices to enhance the WBMB functionality.

The system has advantages of simple use and strong practicability.

It is a fundamental brick in the world of Internet of Things and Internet of Everything. As the WBMB detects any surrounding Wireless physically devices properties event and methods and bridge that to the internet to be controlled.

The present invention provides a method for implementing a “Wi-Fi Bluetooth Multimedia Bridge” (WBMB) for short range wireless systems, as Bluetooth Smart sensors to send its events to long distance.

The major drawback of low energy technologies as described in the background Art, is that there is no computability RF protocol to Wi-Fi routers. For example, although that Bluetooth Classic, and Bluetooth Smart devices work in the same 2.4 Ghz, the RF modulation, channel selection and protocol are totally different. Other low energy technologies has the same none compatibility problems. As NFC, IrDA, Nike+, ANT (+), ZigBee, RF4CE etc.

The outcome of these limitations, are that sensors that uses these technologies cannot send the sensors information's to the internet, since home or public routers do not support other protocols but Wi-Fi. Usually the connection to the internet is done by wireless Wi-Fi or RJ45 Ethernet and the above technologies do not support that.

Therefore, the present invention effectively implements a flexible wireless system that utilizes various heterogeneous components to facilitate optimal system interoperability and functionality. The present invention thus effectively and efficiently implements an enhanced wireless Wi-Fi Bluetooth Multimedia Bridge mode (WBMB).

The WBMB can be placed on tables or hang on a wall or ceiling.

According to an embodiment of the invention there may be provided a multimedia communication bridge that may include: a long range communication transceiver; a short range communication transceiver; a multimedia unit that may include a speaker and a microphone; and a controller; wherein the long range communication transceiver may be configured to communicate, using a first communication protocol, with a remote server the Internet; wherein the short range communication transceiver may be configured to communicate, using a second communication protocol, with multiple local devices; wherein the multimedia communication bridge may be configured to receive a message from one of the local devices; wherein the controller may be configured to generate a message response request to receive instructions for responding to the message; wherein the long range communication transceiver may be configured to transmit the message response request to the remote server and to receive the instructions; wherein the controller may be configured to execute the instructions and to respond to the message.

The message may be a voice command received by the microphone; wherein the instructions may include a textual representation of the voice command.

The controller may be configured to generate, in response to the textual representation of the voice command, a media file retrieval request for retrieving a media file to be played by the multimedia communication bridge; wherein the long range communication transceiver may be configured to transmit the media file retrieval request to the remote server and to receive the media file; wherein the multimedia unit may be configured to play the media file.

The controller may be configured to detect, based upon information provided by the short range transceiver, that a user device may be proximate to the multimedia communication bridge; and wherein the controller may be configured to generate a proximity response request to receive instructions for responding to the proximity of the user device; wherein the long range communication transceiver may be configured to transmit the proximity response request to the remote server and to receive the instructions; wherein the controller may be configured to execute the instructions and to respond to the message.

The multimedia communication bridge may include a proximity sensor; wherein the controller may be configured to receive from the proximity sensor an indication that a user may be proximate to the multimedia communication bridge; and wherein the controller may be configured to generate a proximity response request to receive instructions for responding to the proximity of the user device; wherein the long range communication transceiver may be configured to transmit the proximity response request to the remote server and to receive the instructions; wherein the controller may be configured to execute the instructions and to respond to the message.

The first communication protocol may be Wi-Fi.

The second communication protocol may be Bluetooth or smart Bluetooth.

The multimedia communication bridge may include a set of proximity buttons for receiving instructions from a user.

The multimedia communication bridge may include a set of communication ports for interfacing with at least one local device via a cable.

The multimedia communication bridge may include an infrared remote control unit; wherein the infrared remote control unit may be configured to receive an infrared command; wherein the controller may be configured to generate an infrared command response request to receive instructions for responding to the infrared command; wherein the long range communication transceiver may be configured to transmit the infrared command response request to the remote server and to receive the instructions; wherein the controller may be configured to execute the instructions and to respond and generate infrared command.

The multimedia communication bridge may include a case that that has a cover that contacts the speaker without concealing the speaker; a top panel that encloses the controller, the long range transceiver and the short range transceiver; wherein the case may be connected to the top panel by multiple legs; and wherein the speaker faces the top panel.

The top panel supports a set of proximity buttons.

The multimedia communication bridge may include a reset button, at least one multiple universal serial bus (USB) ports, a power port, at least one non-USB communication port, a microphone input port and an auxiliary audio port.

The multimedia communication bridge may include an infrared remote control unit.

The multimedia communication bridge may include a proximity sensor.

According to an embodiment of the invention there may be provided a multimedia communication bridge that may include a long range communication transceiver; a short range communication transceiver; a multimedia unit that may include a speaker and a microphone; and a controller; a case that that has a cover that contacts the speaker; a top panel that encloses the controller, the long range transceiver and the short range transceiver; wherein the speaker faces the top panel and may be spaced apart from the tip panel; wherein the long range communication transceiver may be configured to communicate, using a first communication protocol, with a remote server the Internet; wherein the short range communication transceiver may be configured to communicate, using a second communication protocol, with multiple local devices.

The top panel supports a set of proximity buttons.

The multimedia communication bridge further may include a reset button, at least one multiple universal serial bus (USB) ports, a power port, at least one non-USB communication port, a microphone input port and an auxiliary audio port.

The multimedia communication bridge may include an infrared remote control unit.

The multimedia communication bridge may include a proximity sensor.

The first communication protocol may be Wi-Fi.

The second communication protocol may be Bluetooth or smart Bluetooth.

The multimedia communication bridge may include a set of proximity buttons for receiving instructions from a user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a Wi-Fi Bluetooth Multimedia Bridge WBMB showing its top proximity buttons panel, inner speaker, one of its USB port according to an embodiment of the invention;

FIG. 2 is the WBMB showing its other side, RJ45, power supply connector, reset switch, and the two other USB port according to an embodiment of the invention;

FIG. 3 shows the WBMB bottom that includes hook holes, Label placement and QR code according to an embodiment of the invention;

FIG. 4 shows the WBMB inner structure with its inner speaker, inner bottom PCB according to an embodiment of the invention;

FIG. 5 shows the WBMB inner bottom PCB and its main components according to an embodiment of the invention;

FIG. 6 shows the WBMB inner bottom plastic according to an embodiment of the invention;

FIG. 7 shows the WBMB inner building block parts according to an embodiment of the invention;

FIG. 8 shows the WBMB plastic case and its main components according to an embodiment of the invention;

FIG. 9 shows the WBMB inner top plastic case according to an embodiment of the invention;

FIG. 10 shows the WBMB top PCB and its proximity buttons and main components according to an embodiment of the invention;

FIG. 11 shows the WBMB device's middle plastic case with an open round hole for the inner speaker according to an embodiment of the invention;

FIG. 12 shows the WBMB system block diagram according to an embodiment of the invention;

FIG. 13 shows the WBMB potential connection to other devices according to an embodiment of the invention;

FIG. 14 shows the WBMB bottom PCB detailed schematics according to an embodiment of the invention;

FIG. 15 top PCB detailed schematics according to an embodiment of the invention;

FIG. 16 is sample of Internet data base server command and event view screen according to an embodiment of the invention;

FIG. 17 Flow chart of a method according to an embodiment of the invention;

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

The present invention relates to an improvement for a wireless Wi-Fi system and enhancing the capabilities to connect to other short range non Wi-Fi wireless devices and bridge them among themselves and to the internet. An example of short range non Wi-Fi wireless devices is a Bluetooth Smart device but not limited to it.

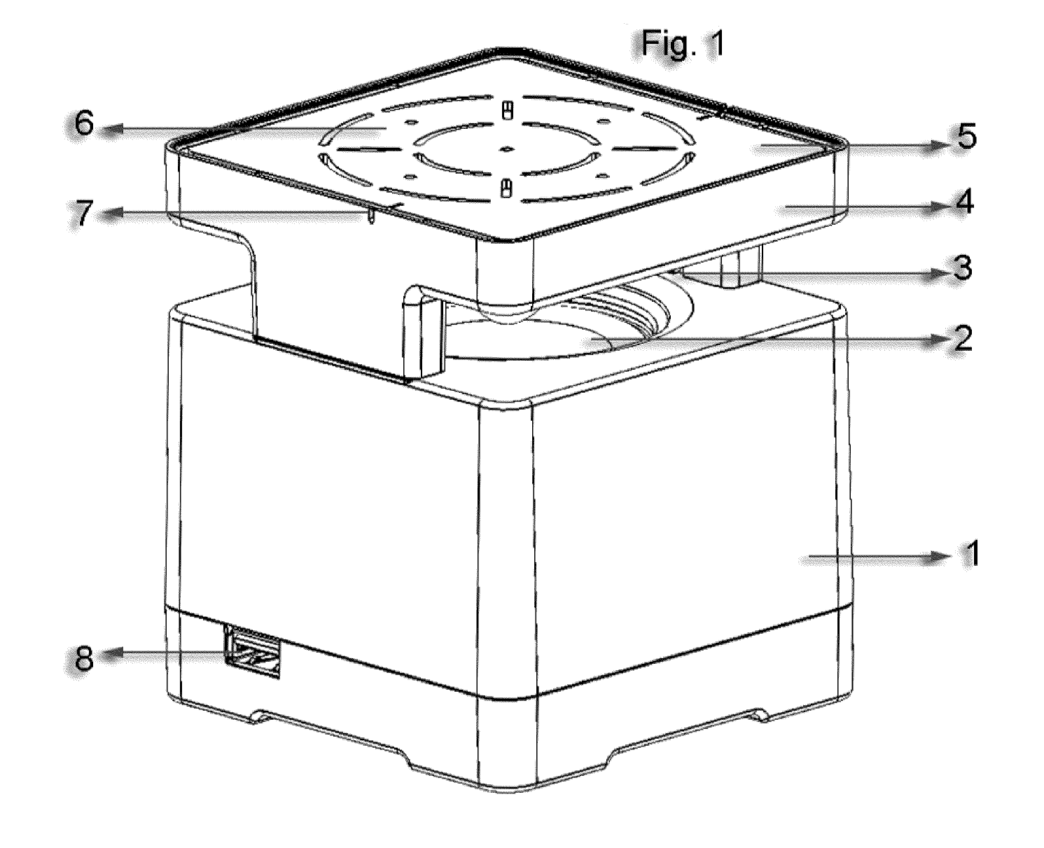

FIG. 1 shows the WBMB case (FIG. 1 1) front. It has plastic cover holding an inner speaker (FIG. 1 2) with face up. Two legs (FIG. 1 3) hold the top panel (FIG. 1 4). The top panel has PCB (FIG. 1 5) PCB top side with its 5 proximity buttons (FIG. 1 6). The top PCB is cover by semi-transparent plastic. And one of the Microphones inputs (FIG. 1 7). The device has also 3 external USB ports (FIG. 1 8).

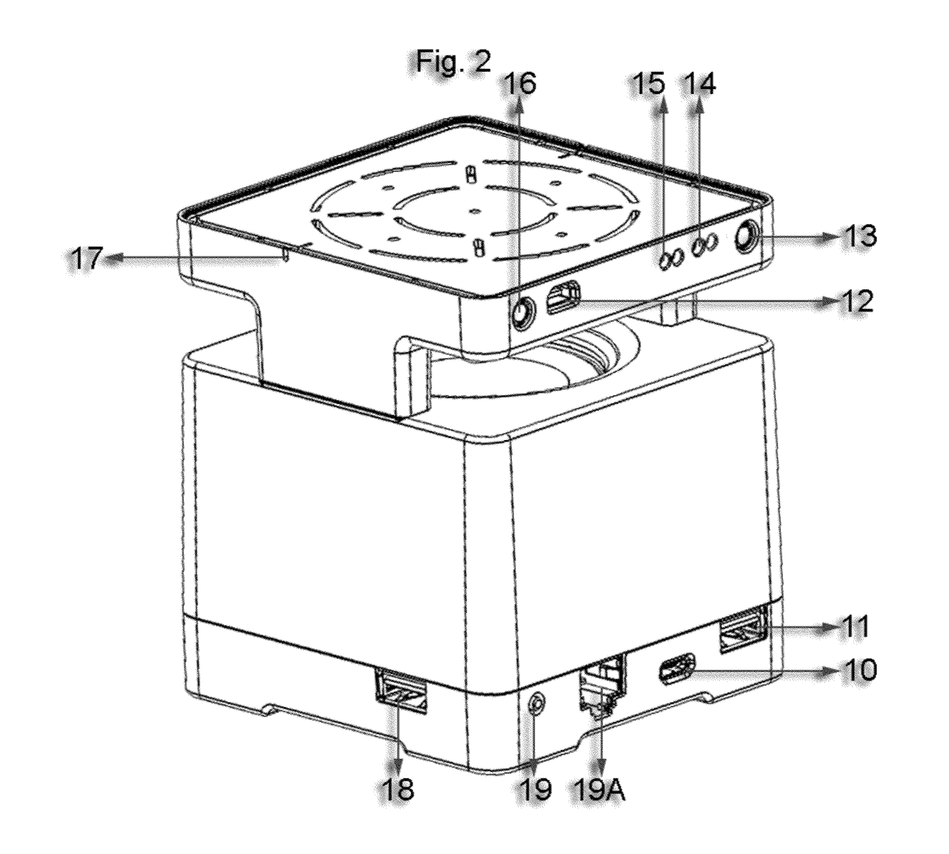

FIG. 2 shows the WBMB case (FIG. 1 1) rear side. The device's power supply (FIG. 2 10) input plug. The second external USB port (FIG. 2 11), The RJ45 Ethernet port (FIG. 2 19A), the reset button (FIG. 2 19), the third external USB port (FIG. 2 18). The second microphone input (FIG. 2 17). The Audio out plug (FIG. 2 16). An external programmable port (FIG. 2 12). The IR remote control sensor (FIG. 2 15). The proximity human body detector (FIG. 2 14) which may be locates at rear and also at front of the WBMB. External input audio plug (FIG. 2 13)

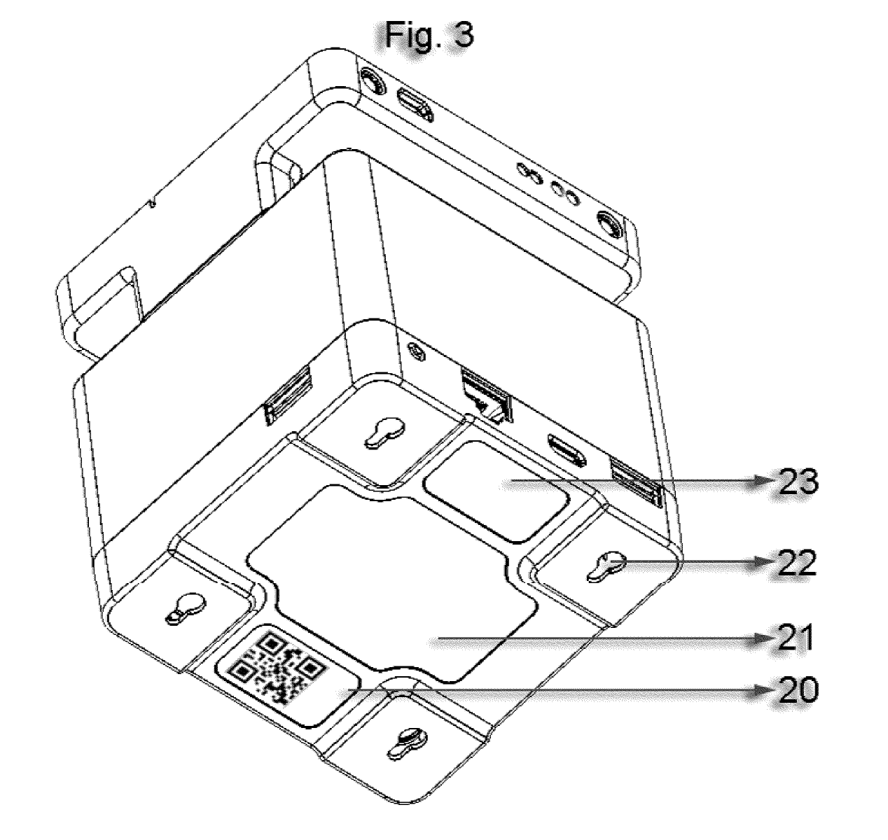

FIG. 3 shows the WBMB bottom side (FIG. 3 21). It has 4 holes, one at (FIG. 3 22), to enable the possibility to hang it on walls, ceiling or just place it on any flat surface as tables. It also has a manufacture guide label (FIG. 3 23) and a QR code (FIG. 3 20) to configure connection with smart phone apps.

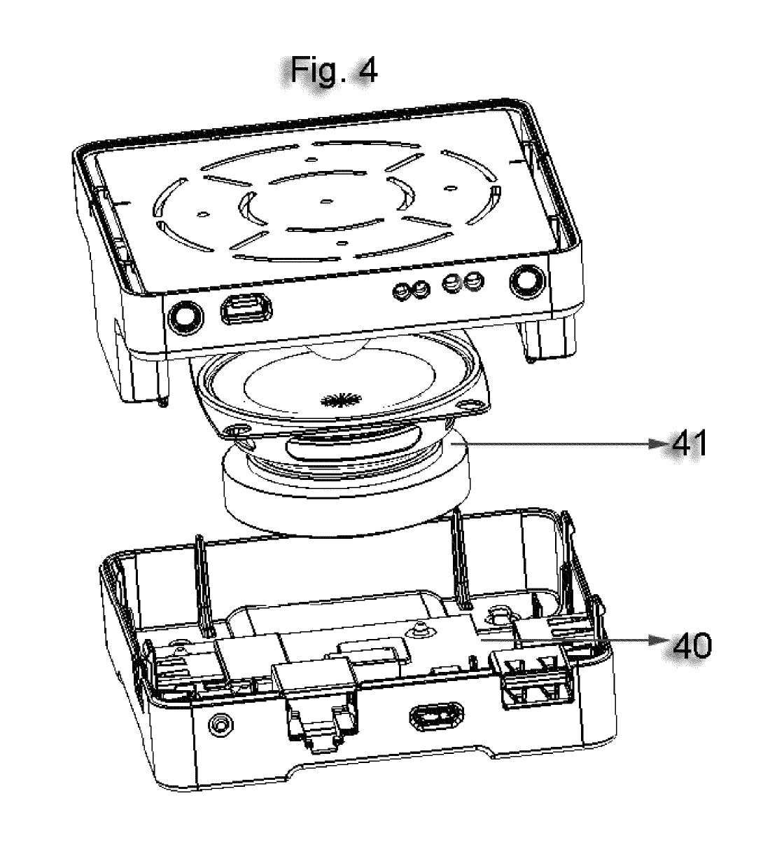

FIG. 4 shows the WBMB inner space. It has a speaker (FIG. 4 41) connected to WBMB audio system and lower PCB (FIG. 4 40)

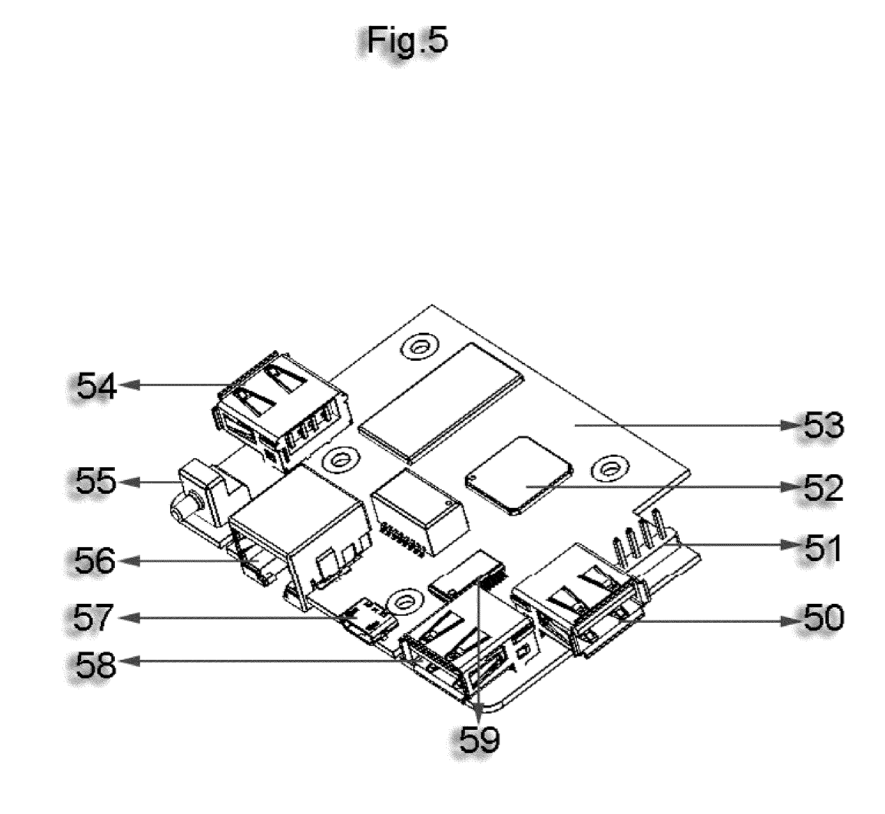

FIG. 5 shows the WBMB lower PCB (FIG. 5 53). The USB external ports (FIG. 5 54) (FIG. 5 58) (FIG. 5 50), these USB ports can host external USB devices or internal, inside USB device. When internal USB device is needed, this port will be placed vertically and not horizontally. It shows also the WBMB RJ45 (FIG. 5 56) port which utilizes to connect to internet when a wireless connection is not available or desire. A reset switch (FIG. 5 55). The main Wi-Fi chip (FIG. 5 52) AR9331. The USB hub (FIG. 5 59) with 4 ports. 3 are on the lower PCB, and one (FIG. 5 51) is used to connect to the upper PCB. WBMB connects to internet using one of 3 methods: RJ45, Wi-Fi or cellular router over USB. The power charger input (FIG. 5 57).

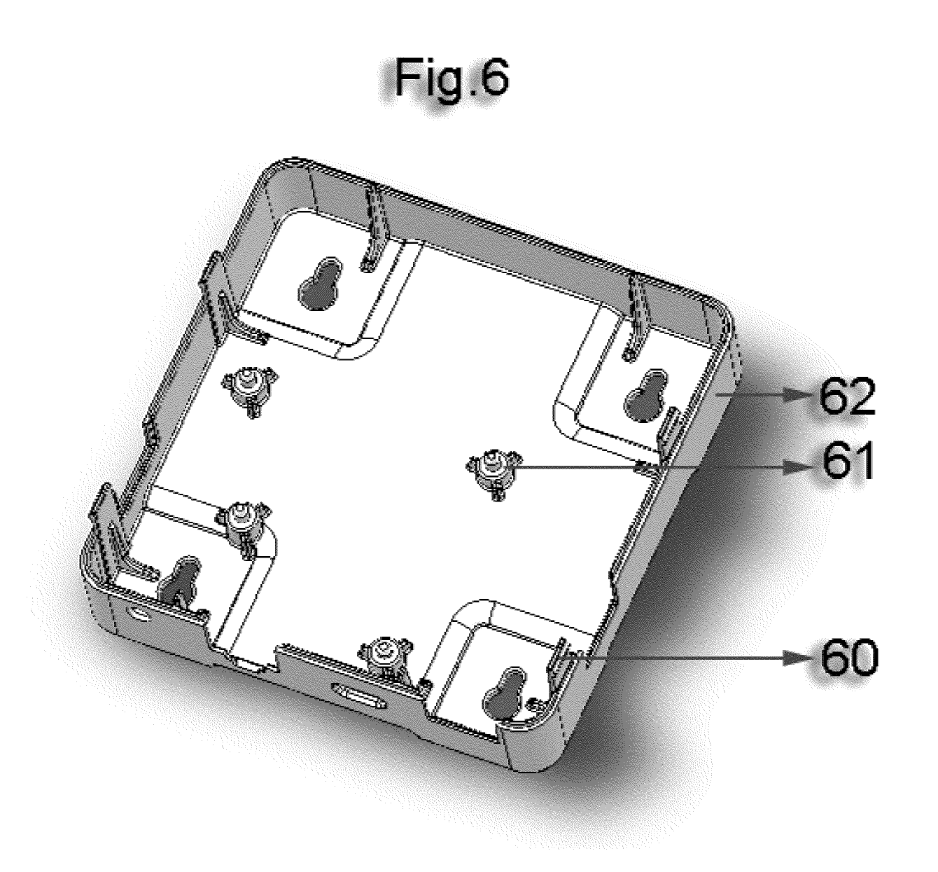

FIG. 6 The WBMB lower plastic case (FIG. 6 62) has two towers (FIG. 6 61) to hold the PCB in the air, and has a tower notch looker (FIG. 6 60) to the middle case.

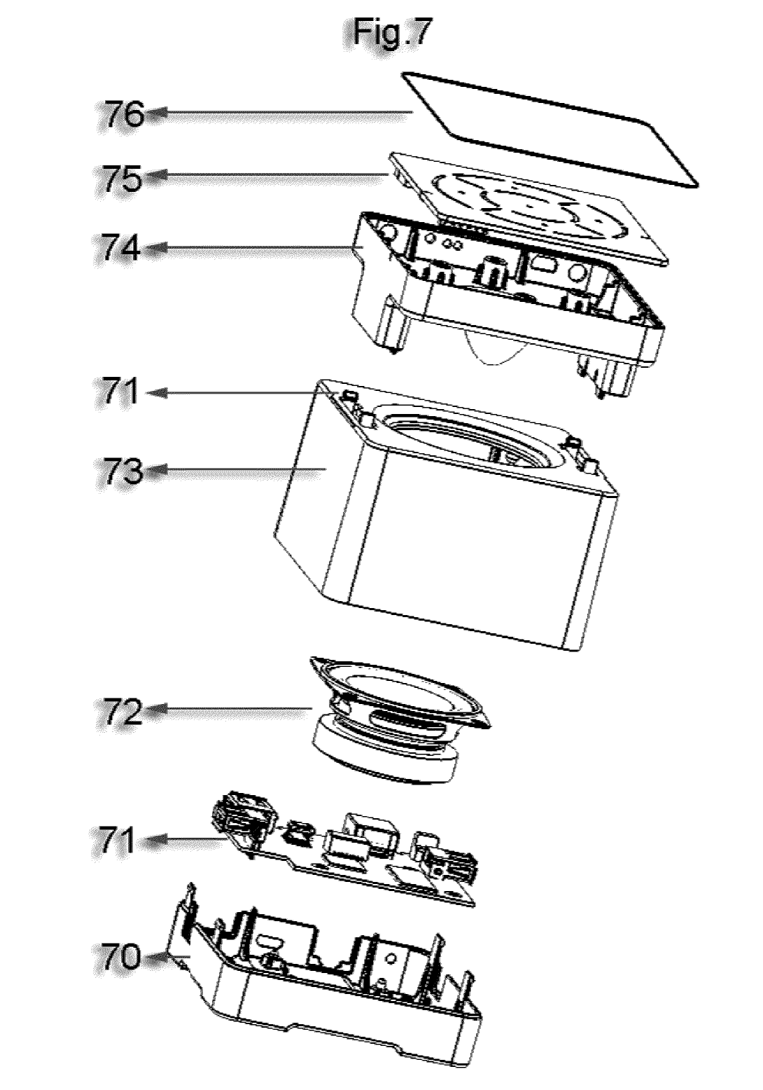

FIG. 7 The WBMB device's open plastic case. The lower case (FIG. 7 70). The lower PCB (FIG. 7 71) with the entire Wi-Fi and multimedia audio components. The inner speaker (FIG. 7 72) that plays any sound by command from the internet data base server. The middle case (FIG. 7 73) with notch (FIG. 7 71) to hold the upper plastic case. The upper plastic case (FIG. 7 74). The upper PCB (FIG. 7 75) and the top plastic cover (FIG. 7 76).

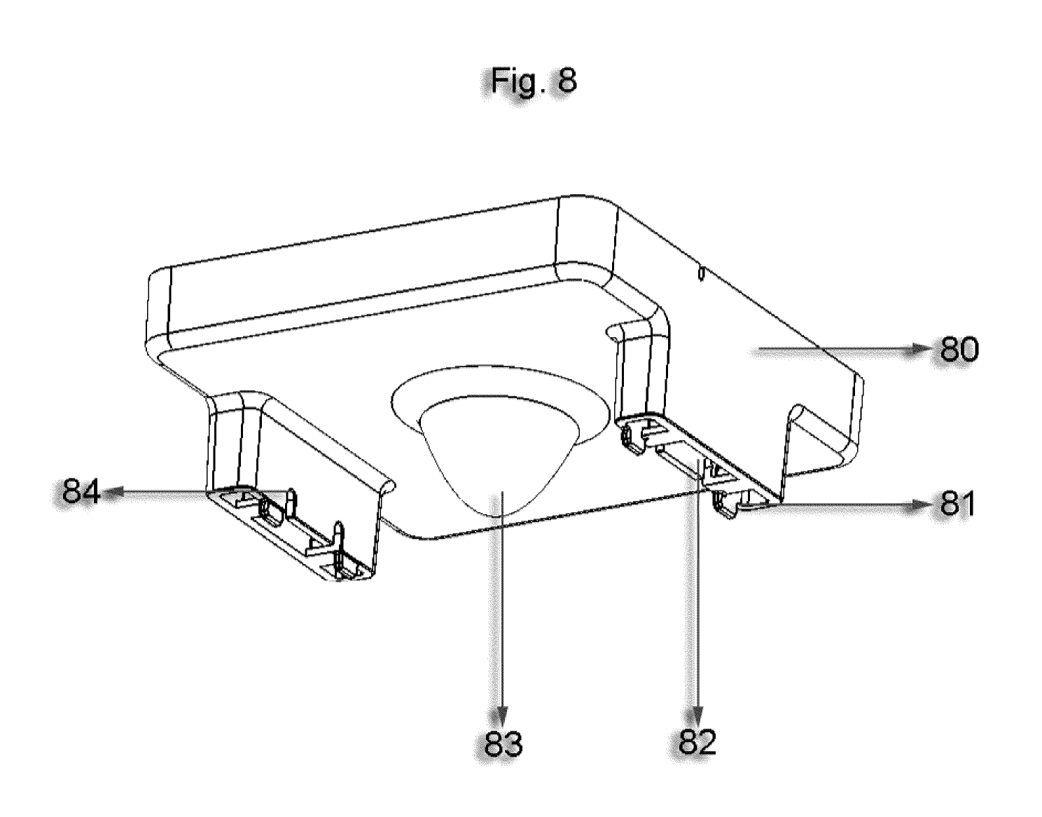

FIG. 8 The WBMB device's top plastic case (FIG. 8 80) has an attached towers to the middle case (FIG. 8 81) and an air tunnel (FIG. 8 82) to allow air pressure from the speaker to flow in and send out (FIG. 8 84) as a audio acoustic filter. The top case has a dome (FIG. 8 83) to reflect the inner speaker audio to all directions.

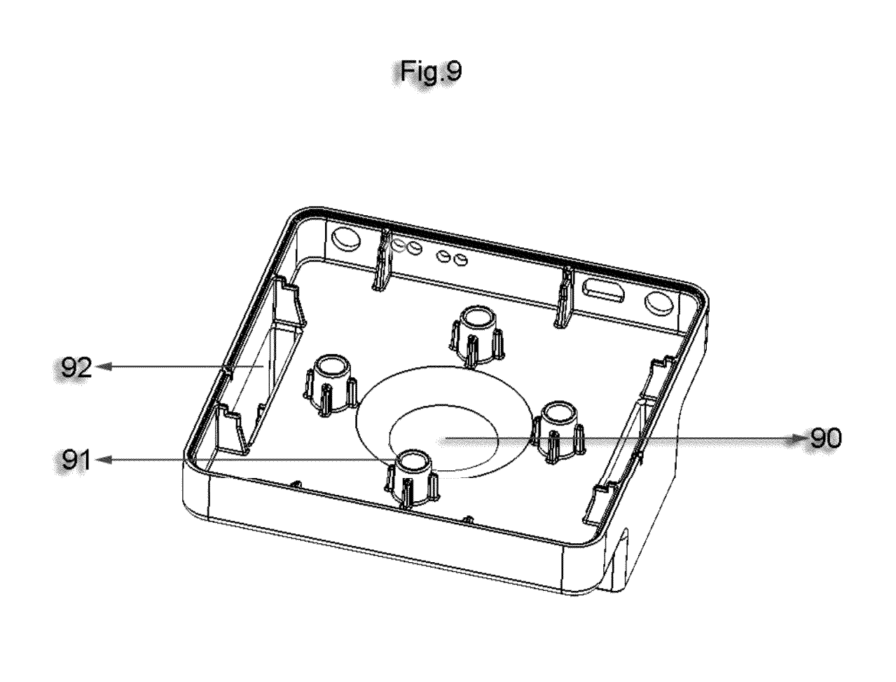

FIG. 9 The WBMB device's top plastic case (FIG. 9 90) top side. It has towers to hold the top PCB (FIG. 9 91). Air tunnel for the speaker air pressure (FIG. 9 92). And the dome other side (FIG. 9 90).

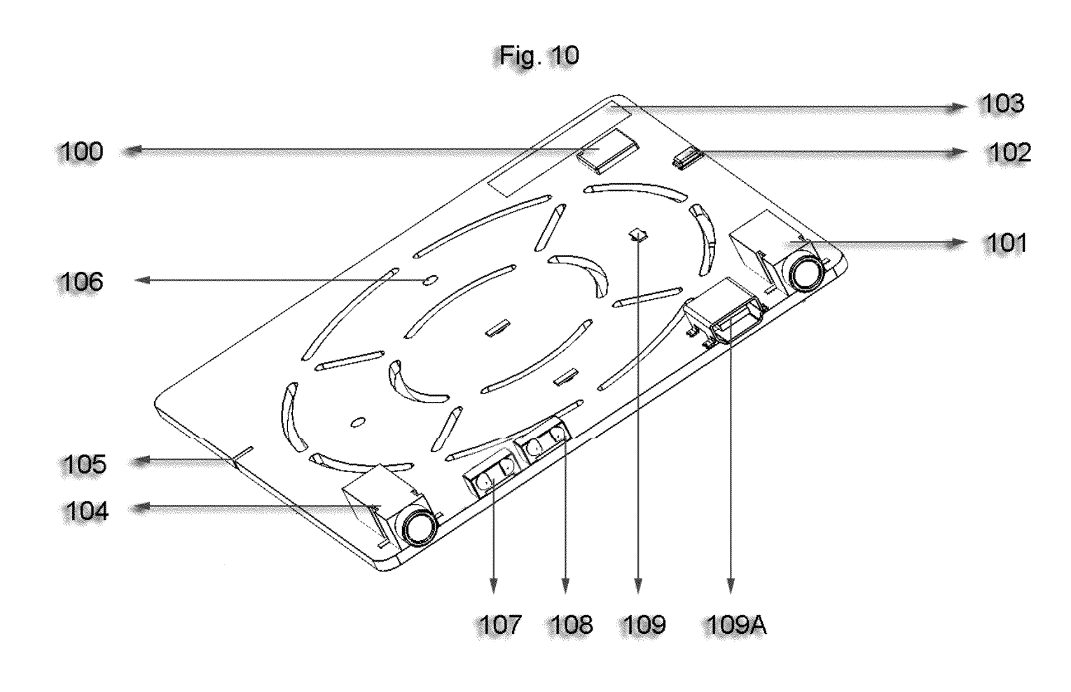

FIG. 10 The WBMB device's top PCB. It has an audio out port (FIG. 10 104). IR programmable remote control (FIG. 10 107). A proximity sensor (FIG. 10 108) to detect the proximity of the user near the WBMB (FIG. 10 108). An external programming port (FIG. 10 109A). And Audio input port (FIG. 10 101). A digital microphone (FIG. 10 102). A PCB antenna (FIG. 10 103). A Bluetooth Smart ready chip from CSR. CSR8670. A unique proximity button with holes (FIG. 10 106) to reverse led illumination (FIG. 10 109) which light under the touched area button. There are 5 proximity touched area buttons and the PCB is cut around them, so RGB led can light below and been seen through this cut PCB while user can swap his finger: moving up, down, right, left and OK in the middle. Since the digital microphone has the audio input on its bottom PCB side, there is a cut (FIG. 10 105) to allow external audio to flow into the digital microphones hole.

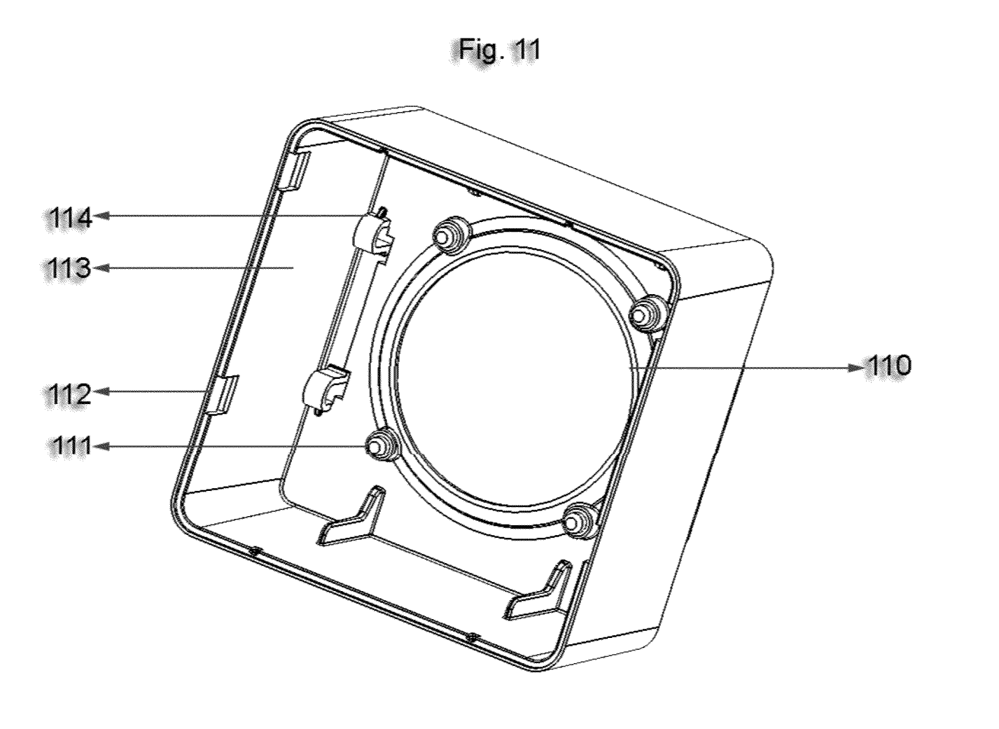

FIG. 11 The WBMB device's middle plastic case (FIG. 11 113) has notch (FIG. 11 112) to hold the lower case towers. Hold (FIG. 11 114) for the top plastic case towers. And an open cavity (FIG. 11 110) for the inner speaker, that is attached by towers (FIG. 11 111).

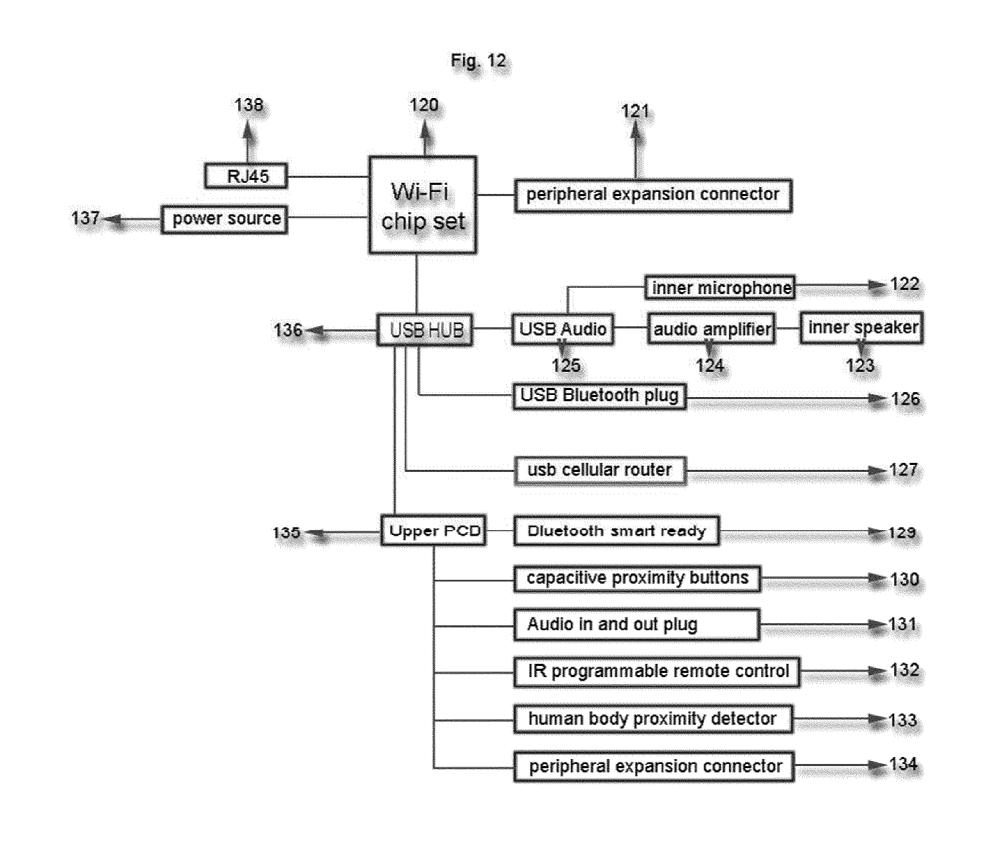

FIG. 12 Referring to invention architecture for the WBMB. The heart of the WBMB is a Wi-Fi chip set (FIG. 12 120). This chip set is running a Linux OS and expose a web interface. Using this web interface makes it is possible to update the inner firmware and monitor, to see events and send command setting to all the Bluetooth Smart devices in the range of the WBMB devices.

The Wi-Fi chip set (FIG. 12 120) connects also to inner expansion connector (FIG. 12 121). This connector exposes the Wi-Fi chip set (FIG. 12 120) free GPIO, power, Speaker output and Microphone input. Thus external wired devices can be connected to the WBMB device. Wi-Fi chip set (FIG. 12 120) has a PCB antenna and a RF connector for bigger and longer range. Wi-Fi chip set (FIG. 12 120) has also an Ethernet RJ45 to enable the WBMB device, link to other routers as ADSL or cable routers over cable and not wireless. In this mode, the Bluetooth Smart device, in the range of the WBMB will be bridged to the internet data base server over cable and not by a RF broadcast. This function is important when secure information needs to be bridge and send to internet data base server.
Wi-Fi chip set (FIG. 12 120) gets its power from Micro USB plug (FIG. 12 137). This is most common plug in smart phone to allow battery charging. This plug (FIG. 12 137) delivers 5V to the WBMB device. The power plug has also UART TX and RX line of Wi-Fi chip set (FIG. 12 120) connector to its free pins. This enables to program the WBMB by using terminal, as PuTTY application from PC. This programming UART channel is normal implement as USB-UART and it interfaces to Wi-Fi chip set (FIG. 12 120) Linux inner terminal.

The Wi-Fi chip set (FIG. 12 120), one USB port is connected to 4 port USB hubs (FIG. 12 136). The 4 port of USB hub (FIG. 12 136) is used to connect to USB audio chip set (FIG. 12 125) to allow the WBMB to play sound. The USB audio chip set (FIG. 12 125) is connected to class D audio amplifier (FIG. 12 124) to drive the inner speaker (FIG. 12 123) (FIG. 7 72). The USB audio chip set (FIG. 12 125) is connected to inner microphone (FIG. 12 122) too. This Microphone is used in a way that the WBMB can capture user voice command, bridge the voice to the internet speech recognition services and gets the recognized text as a respond. Send the recognized text to WBMB Internet data base server and retrieves a voice file to be played to user or to command the Bluetooth Smart device in the range of the WBMB devices.

The USB hub (FIG. 12 136) is connected also to USB Bluetooth Smart plug that can connect to Bluetooth Smart device in the range of the WBMB devices or with Bluetooth Classic devices. The USB plug (FIG. 12 126) to be used is CSR8510 A10.

Wi-Fi chip set (FIG. 12 120) other USB port connects to USB cellular plug router (FIG. 12 127), to enable the WBMB bridges the Bluetooth Smart device in the range of the WBMB devices to the Internet data base server when there is no nearby ADSL or Cable router.

Wi-Fi chip set (FIG. 12 120) other USB port connects to the Upper PCB (FIG. 12 135). This allows the Wi-Fi chip set (FIG. 12 120) to open a communication channel with Upper PCB (FIG. 12 135). This communication channel from the Upper PCB (FIG. 12 135) feeds event to Wi-Fi chip set (FIG. 12 120) and sends command to Upper PCB (FIG. 12 135). Events are all that can be detected by the Upper PCB (FIG. 12 135) and command is all that the upper PCB can do.

The Upper PCB (FIG. 12 135) has a Bluetooth Smart ready chip CSR8670 (FIG. 12 129) from CSR. This chip support RF communicating channel to Bluetooth Smart devices and to Bluetooth classic devices.

CSR8670 Features are:

1. Bluetooth® smart specification fully qualified software.
2. Radio includes integrated balun

### 3. 80 MHz RISC MCU and 80MIPS Kalimba DSP

4. 16 Mb internal flash memory (64-bit wide, 45 ns);
5. Stereo codec with 2 channels of ADC and up to 6 microphone inputs (includes bias generators and digital microphone support)
6. Support for CSR's latest CVC technology for narrow-band and wide band voice connections including wind noise reduction
7. Audio interfaces: I²S, PCM and SPDIF
8. Serial interfaces: UART, USB 2.0 full-speed, I²C
9. Integrated dual switch-mode regulators, line regulators and battery charger
10. 3 hardware LED controllers (for RGB) and ability to drive LCD segment display directly
11. Support for up to 6 capacitive touch sensor inputs
12. 6.5×6.5×1 mm, 0.5 mm pitch 112-ball VFBGA

This CSR8670 (FIG. 12 129) on the Upper PCB (FIG. 12 135) has 6 capacitive proximity buttons (FIG. 12 130). The buttons are arranged in a round shape circle with center button. If a local setting needs to done on the WBMB, the user can swap his finger right to left, left to right, top to bottom and bottom to up, to make a selection. The menus selection is given in voice menu using the inner speaker. This CSR8670 (FIG. 12 129) has a connection to external audio input and output (FIG. 12 131) to drive external audio system as home multimedia center.

This CSR8670 (FIG. 12 129) is also connected to IR programmable remote control chip set (FIG. 12 132). This IR controller can learn from exiting “old” remote control, and send this information to Internet data base server using the CSR8670 (FIG. 12 129) communicating channel to Wi-Fi chip set (FIG. 12 120), when the user gives voice command to his TV, or any other IR enable devices. The voice command is sent to Internet search recognition service, the WBMB retrieves the text and sends it to WBMB internet data base server to retrieve a proper voice reply to user and/or sending command to Bluetooth Smart device in the range of the WBMB devices.

This CSR8670 (FIG. 12 129) is also connected to human body proximity detector chip (FIG. 12 133). When a user approaches the WBMB device, the WBMB plays a voice menu to the user. For example: if internet radio is playing, the menu can be “sweep your finger UP or DOWN to change the volume and right or left to change to change channel”.

This CSR8670 (FIG. 12 129) is also connected to peripheral expansion connector (FIG. 12 134). This connector bridges the CSR8670 (FIG. 12 129) to other wired sensors and devices, and allow to program the CSR8670 (FIG. 12 129).

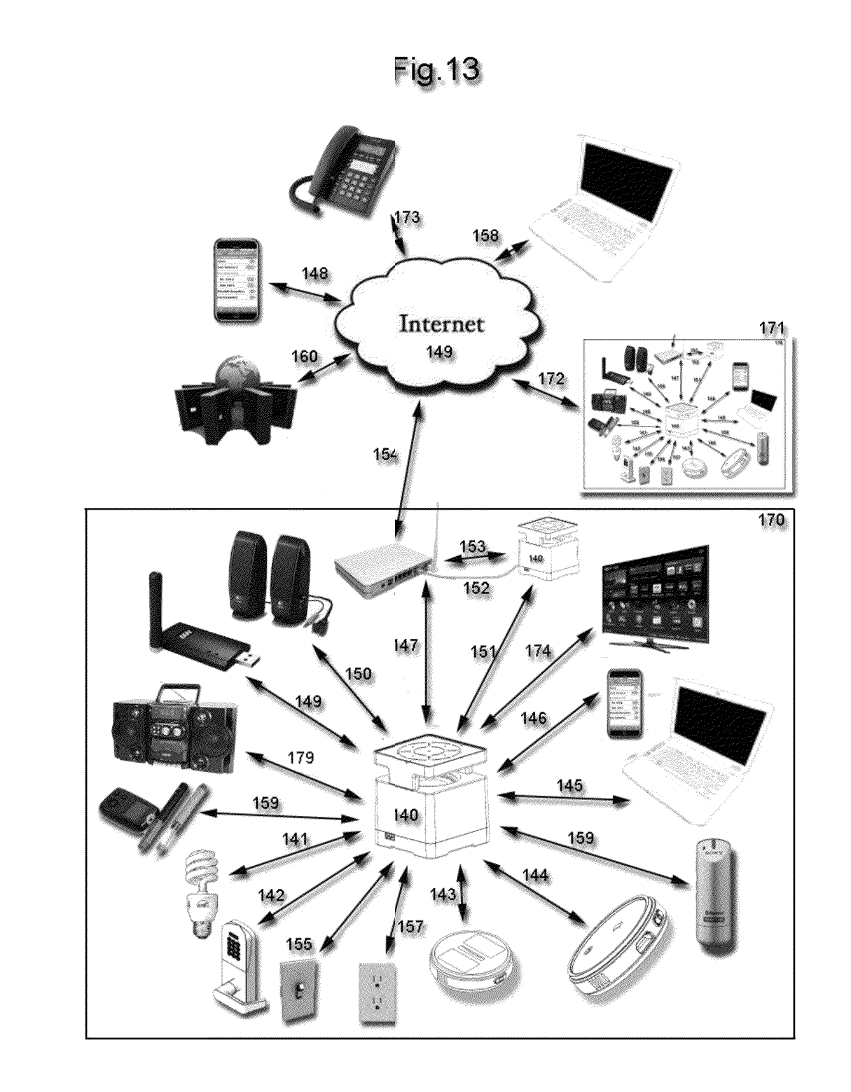

FIG. 13 The WBMB invention serves as center for “Internet of Thing” concept in-sites as homes and public places. WBMB invention apparatuses, methods and systems target to solve the main problem of bridging information from non Wi-Fi devices to the internet. WBMB becomes the “Internet of Thing” home server for a non-Wi-Fi sensors and a Wi-Fi devices.

At public or home places WBMB (FIG. 13. 140) can wirelessly sense present nearby user's smart phone (FIG. 13. 148) by its MAC address or the user's keyfob (FIG. 13. 143) Bluetooth Smart MAC address. All senses MAC's are sent to Internet data base server (FIG. 13. 160) to retrieve command. The Command is used for authentication and operates nearby devices. The user recognition is done by bridging the information from the WBMB (FIG. 13. 140) to Internet data base server (FIG. 13. 160), retrieves respond command and sends command to nearby devices as door lock, light bulb,

Door lock (FIG. 13. 142). The door Bluetooth Smart device in the range of the WBMB does not need to recognize the user's smart phone (FIG. 13. 146) or use keyfob (FIG. 13 143). It's enough that the Internet data base server (FIG. 13. 160) recognizes the user to open the door (FIG. 13. 142) when the user is nearby. WBMB (FIG. 13. 140) automatically closes the door when user is away. The “nearby” and “away” is recognized by User Bluetooth Smart device RSSI in the range of the WBMB devices.

Light bulb (FIG. 13. 141). The bulb or its hosing is a Bluetooth Smart device in the range of the WBMB device, does not need to recognize the user smart phone (FIG. 13. 146) or use keyfob (FIG. 13 143) to be operated.

It's enough that the Internet data base server (FIG. 13. 160) recognizes the user to send command to light the bulb (FIG. 13. 141) based on day/night time when the user is nearby. WBMB (FIG. 13. 140) automatically closes the light when user is away. The “nearby” and “away” is recognized by user Bluetooth Smart device RSSI in the range of the WBMB device. Light bulb (FIG. 13. 141) can be commanded also to light from the user smart phone (FIG. 13. 146) or any other device that can communicate with WBMB (FIG. 13. 140) For example user's PC (FIG. 13. 145), Wireless Microphone (FIG. 13. 159), wall electric switch (FIG. 13. 155), door handle (FIG. 13. 142), Internet web site (FIG. 13. 149), far smart phone (FIG. 13. 148), schedule data and time from Internet data base server (FIG. 13. 160), Bluetooth Smart light sensor that reports to WBMB device (FIG. 13. 140).

In elevators, the WBMB (FIG. 13. 140) can detect the presence of the user by its recognized Bluetooth Smart device, or smart phone in the range of the WBMB and play its preferred songs using internal speaker or over external speakers (FIG. 13. 150). The preferred songs are retrieved using Internet data base server (FIG. 13. 160) based on the user “MAC's”.

At public places the WBMB device (FIG. 13. 140) can detect the presence of the user by its recognized Bluetooth Smart device in the range of the WBMB and advertise target advertisement or information over a near Electronic Billboards (FIG. 13. 174). For example, at airport terminal, when the user is recognized by its smart phone or Bluetooth Smart tag. Or at home displaying needed information to his TV display.

At airports terminals, shopping malls or any large public spaces, when the user is recognized by its smart phone or Bluetooth Smart tag information. The information on display (FIG. 13. 174) can be focused on the user's needs, as directions, and other information will not be shown.

When the user is in front of Airport terminal Billboards display and stops near one display (FIG. 13. 174). WBMB (FIG. 13. 140) detects his nearby presence and displays the gate number, boarding time and directions. This information is pulled from Internet data base server (FIG. 13. 160).

At shopping malls, recognition of the user as described above can result of targeting advertisement based on the user's profile. If the user is defined at Internet data base server (FIG. 13. 160) that he likes to get new “laptop”, when he will step into shopping mall he will see on the nearby display an advertisement of the nearby shop with “laptops” with the prices and direction to the shop. When he will walk into the shop, he will see on the nearby display directions to the shelves with “laptops”. Also when WBMB (FIG. 13. 140) detects the user nearby presence, it can send SMS or any other electronic message to his smart phone (FIG. 13. 148).

The WBMB (FIG. 13. 140) has a Bluetooth Smart profile that can work with Bluetooth Smart health (FIG. 13. 159) device. As Bluetooth Smart glucometer, Bluetooth Smart insulin pen, Bluetooth Smart heart rate monitor and many other.

The WBMB (FIG. 13. 140) methods and systems working with medical devices as describe above is extremely important because most of Bluetooth Smart devices communicate only with smart phones. In many cases there is no smart phone around in range. Therefore a fix locating presence of WBMB (FIG. 13. 140) will solve many needs.

Bluetooth Smart health (FIG. 13. 159) device as glucometer when reporting directly to WBMB (FIG. 13. 140), the information is sent to Internet data base server (FIG. 13. 160) and a voice guide can be retrieved. This voice guide can be played on the internal speakers to inform the user how to monitor his pills or to use insulin pen. The insulin pen usage and dosage is also monitored by the WBMB device (FIG. 13. 140), and the missed use can be reported to the user care taker. The user's pills cap also can be monitored, if it has a Bluetooth Smart tag attached, and the opening and closing will be reported to WBMB (FIG. 13. 140) and to Internet data base server (FIG. 13. 160). Setting of timely consummation of the pills can be set by the care taker and forward to the pills' cap tag. Voice reminding can be played on pills consumption time.

Voice reminding can be played on the WBMB device (FIG. 13. 140) inner speaker to remind user to consume pills at the right time. WBMB (FIG. 13. 140) will command the pill cap tag.

WBMB (FIG. 13. 140) supports BT HID profile with added invented function as bridging BT keyboard as in door handle to Internet data base server (FIG. 13. 160) and commands to open the door if user key is at the right code. Since the code is software server bases, it can be changed periodically. And can also enable usage of the same passkey code to multiple doors in public building or restrict some from remote.

WBMB (FIG. 13. 140) supports BT HID profile with added invented functions as bridging the BT wall electric switch (FIG. 13. 155) to Internet data base server (FIG. 13. 160) and commands to open the light on the BT light bulb (FIG. 13. 141).

WBMB (FIG. 13. 140) supports BT health thermometer profile with added invented functions as bridging the health thermometer to Internet data base server (FIG. 13. 160) and commands WBMB (FIG. 13. 140) to play the thermometer level by human voice on the WBMB (FIG. 13. 140) speaker.

WBMB (FIG. 13. 140) supports BT infrared sensor thermometer profile with added invented function as bridging that data profile to Internet data base server (FIG. 13. 160). The Internet data base server (FIG. 13. 160) can use the WBMB (FIG. 13. 140) to generate many responds due to this event, and playing a warning message on WBMB (FIG. 13. 140). In the case that BT tag monitors a baby at night, the Internet data base server (FIG. 13. 160) sends electronic message to user smart phone.

WBMB (FIG. 13. 140) can switch on and off, wall electric power (FIG. 13. 157) based on profile defined by the user on Internet data base server (FIG. 13. 160). It can also monitor power consumption and reports that. Since the presence of the user in the site is also monitored (by user's BT device RSSI) the wall electric power (FIG. 13. 157) can switch on and off automatically by WBMB (FIG. 13. 140) to preserve power.

WBMB (FIG. 13. 140) has an internet link and with Internet data base server (FIG. 13. 160) it can close or open or calibrate any environmental controlled devices in the house. As air condition or heater.

WBMB (FIG. 13. 140) links to any BT sensors in the house, as smoke tag, fire tag, alarm tag, gas detection tag etc, and report their events' activities to Internet data base server (FIG. 13. 160). The Internet data base server (FIG. 13. 160) can generate events as electronic messages to smart phones (FIG. 13. 148) or to PCs (FIG. 13. 158), voice messages to speakers (FIG. 13. 150), phone calls (FIG. 13. 173) in the site (FIG. 13. 170) or at any other site (FIG. 13. 172) (FIG. 13. 171) or hosting WBMB (FIG. 13. 140) too.

WBMB (FIG. 13. 140) can link to other local WBMB devices (FIG. 13. 153) by its Wi-Fi functions as Router and Station in the same time. This allows the WBMB devices (FIG. 13. 140) to cover large areas of Bluetooth Smart devices in the range of any available WBMB device.

Since All WBMB devices (FIG. 13. 140) and (FIG. 13. 171) are linked to same Internet data base server (FIG. 13. 160). Events that the Internet data base server (FIG. 13. 160) detect on one WBMB (FIG. 13. 140) site (FIG. 13 170) can generate responds also on other site of WBMB device (FIG. 13. 171).

The WBMB (FIG. 13. 140) with its Internet data base server (FIG. 13. 160) can generate wide voice messages as needed in case of fire in public places. Or flashing light at home for hearing impair.

WBMB (FIG. 13. 140) located in an hospital room (FIG. 13. 170), monitors health BT tag, as BT patient heart rate, can report alarm on other sites as nurses' station (FIG. 13. 171).

Linked WBMB (FIG. 13. 140) to other WBMB devices (FIG. 13. 140) on long public corridors and rooms, can detect people movements and locations. As needed in some hospitals, Airport terminals or shopping malls.

The WBMB (FIG. 13. 140) supports Bluetooth Smart devices and Bluetooth Classic. With this ability it can detects a BT microphone (FIG. 13. 159) and bridge that to search recognition internet server to carry user voice command at local BT device. As “light on”. “Switch to sports channel” on TV.

The WBMB (FIG. 13. 140) can connect also to tag (FIG. 13. 144) with port to wire output devices. In this mode the WBMB (FIG. 13. 140) can control devices that do not have Bluetooth Smart capabilities. As garage door.

The WBMB (FIG. 13. 140) can connects also to tag (FIG. 13. 144) with port to wire input devices. In this mode the WBMB (FIG. 13. 140) can sense the environment without the link of Bluetooth Smart capabilities. To tag (FIG. 13. 144) wires input can be connected to house none BT temperature sensors.

The user's local in-site PC (FIG. 13. 144) is also linked to WBMB device. And since the WBMB (FIG. 13. 140) expose Wi-Fi playing capabilities, as AirPlay protocols, it bridges playing music sent by PC (FIG. 13. 145) iTunes and iPhone to Home multimedia entertain system (FIG. 13. 179), or Speakers (FIG. 13. 150).

Since WBMB (FIG. 13. 140) exposes also legacy Bluetooth Classic, it imitates Bluetooth Classic headset and bridge music in this channel to Home multimedia entertain system (FIG. 13. 179), or Speakers (FIG. 13. 150).

The user's local in-site PC (FIG. 13. 145) and its smart phone (FIG. 13. 146) is also linked to WBMB device. And since the WBMB (FIG. 13. 140) is linked with Internet data base server (FIG. 13. 160) with web interface, it bridges requests to listen to internet radio and retrieves music from internet radio stations and send it to its local speaker, Home multimedia entertain system (FIG. 13. 179) or Speakers (FIG. 13. 150).

In cases there is no Wi-Fi connection to internet router, it can use one of its open USB port to host cellular link (FIG. 13. 149) to the internet.

WBMB (FIG. 13. 140) can connects to internet router (FIG. 13. 154) by Wi-Fi (FIG. 13. 147) or by RJ45 cable (FIG. 13. 152).

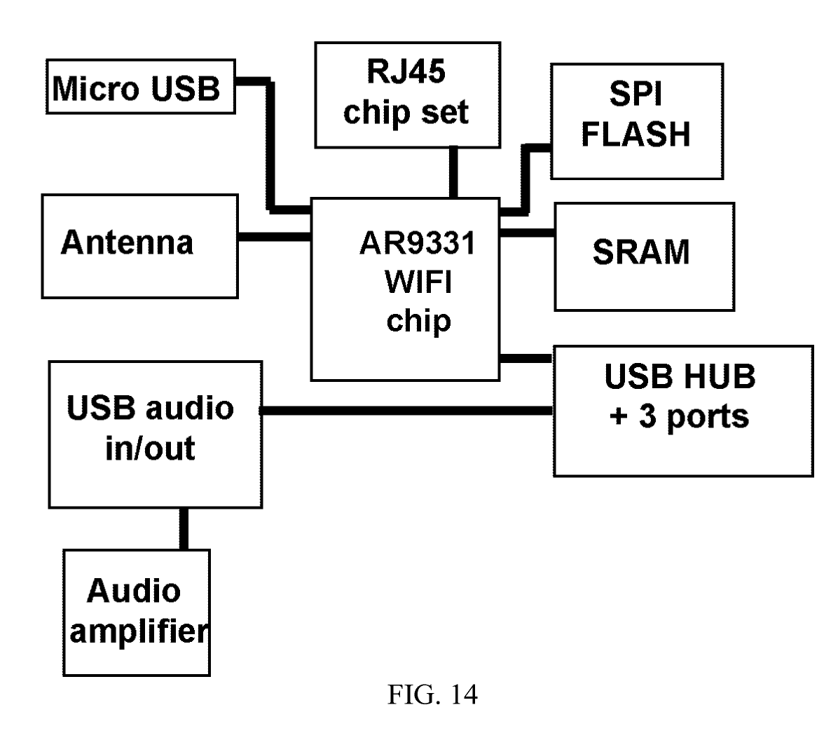

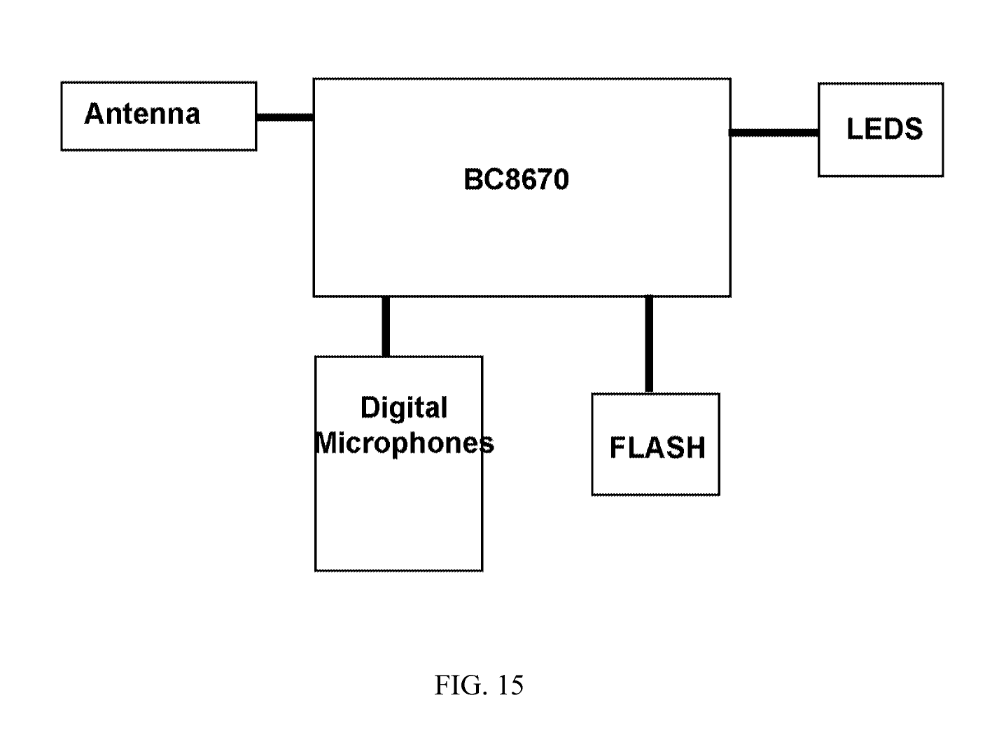

FIG. 14 is a detailed schematic diagram of the bottom Wi-Fi chip set (FIG. 12 120)—PCB. The schematic is self-explanatory for enabled one skilled in the art to make and practice the invention. Several skilled in the different art fields needed to make and practice the invention. An hardware design engineer. An RF design engineer, a firmware software designer, an algorithms designer, a power supply designer for the green technologies compliant, mechanical plastic designer, and a smart phone apps designer. All components data sheet are at the public domain and easy be retrieved. The present invention does not limit itself to the present selection of the components and any other components with the same punctuality can easily be use. FIG. 15 is a detailed schematic diagram of the top PCB with CSR8670. The schematic is self-explanatory for enabled one skilled in the art to make and practice the invention. Several skilled in the different art fields needed to make and practice the invention. An hardware design engineer. An RF design engineer, a firmware software designer, an algorithms designer, a power supply designer for the green technologies compliant, mechanical plastic designer, and a smart phone apps designer. All components data sheet are at the public domain and easy be retrieved. The present invention does not limit itself to the present selection of the components and any other components with the same punctuality can easily be use.

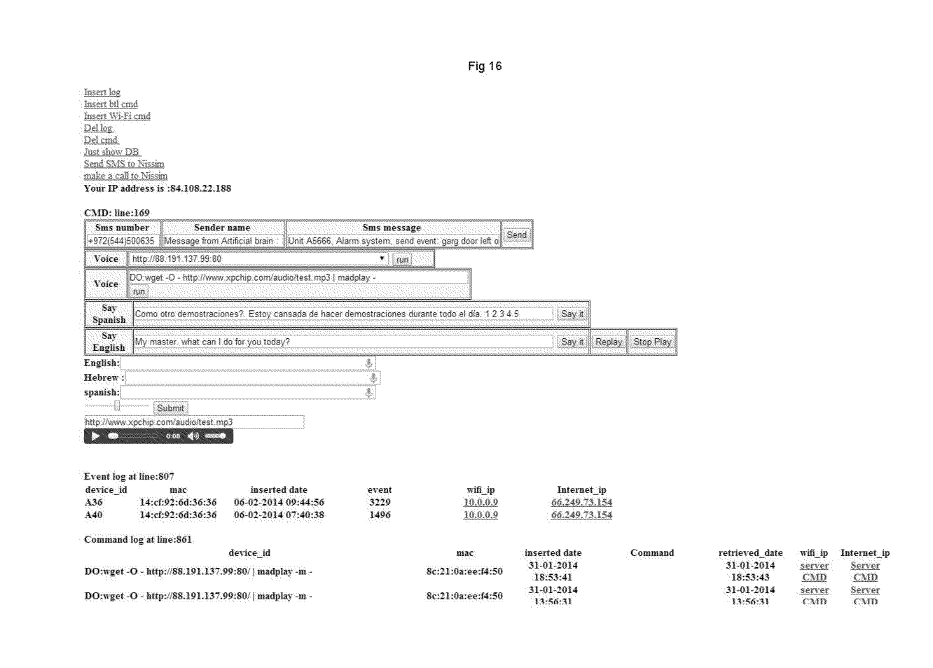

FIG. 16 is sample of Internet data base server (FIG. 13. 160) command, setting and event view screen.

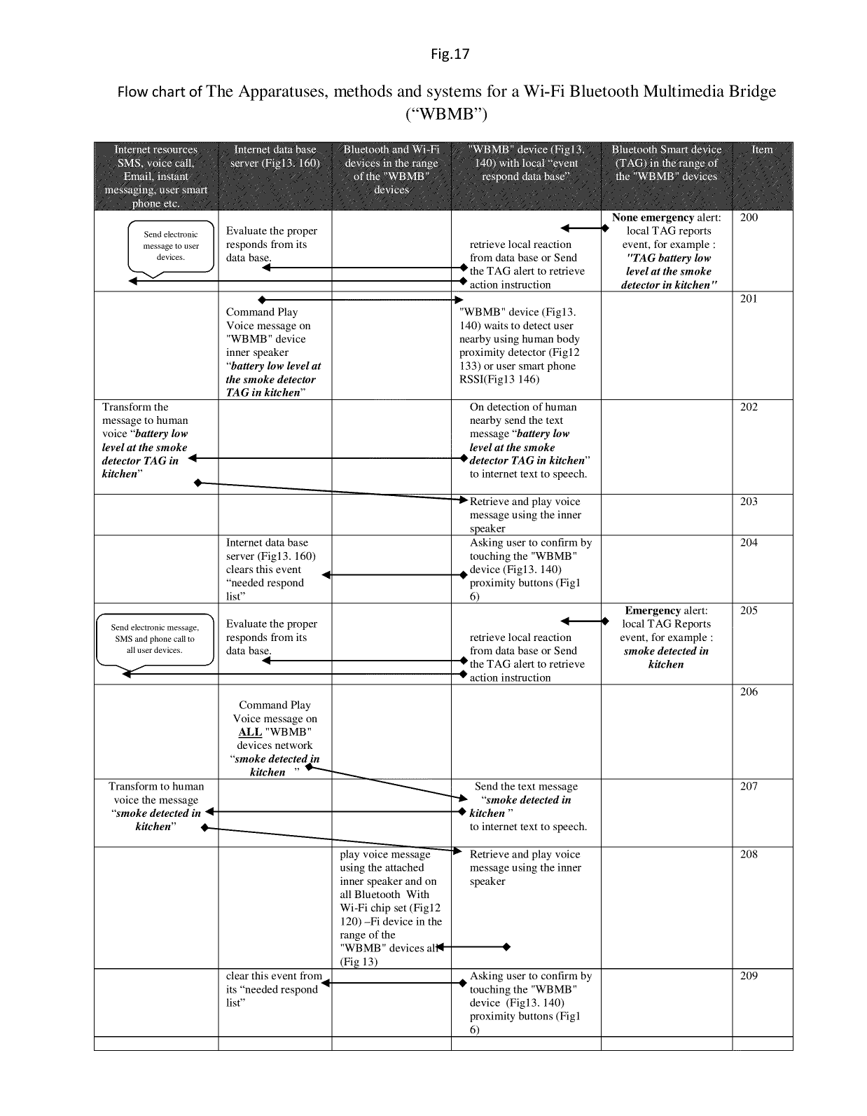

FIG. 17 is the Flow chart of The Apparatuses, methods and systems for a Wi-Fi Bluetooth Multimedia Bridge (WBMB). The Flow chart is self-explanatory.

Another embodiment of the invention is its method to receive events from Bluetooth Smart device.

Another embodiment of the invention is its method to transmit the events from Bluetooth Smart device to internet data base center.

Another embodiment of the invention is its method to retrieve commands from internet data base server based on the WBMB unique MAC address.

Another embodiment of the invention is its method to execute the command within WBMB device, for example to start playing sound file, or to start retrieve internet radio station; and

Another embodiment of the invention is its method to retrieve command from internet data base server based on the Bluetooth Smart unique MAC address sensors linked to WBMB device; and

Another embodiment of the invention is its method where the data base on the internet sends a command to WBMB to play a Text to Speech respond in any language as a reaction of event from one of the Bluetooth Smart sensor event. For example: Bluetooth Smart smoke sensor wireless connects to WBMB device, in case of fire, the fire event sends from the sensor to WBMB and the WBMB sends to internet data base center. The Internet data base server sends command to WBMB to make a sound by a human voice in English as: “There is a fire in the kitchen. Leave the house now” or in any other language. In the same time internet data base server can send SMS or generate a phone call to the owner of the house or to the fire department.

Another embodiment of the invention is its method which WBMB exposes a web base interface allow internet and smart phone access for sensor event retrieve or send a command to be activated. For example: to send a command from user smart phone to light a light bulb. The user smart phone is linked to WBMB and a light bulb has Bluetooth Smart controller wirelessly linked to WBMB too.

Another embodiment of the invention is its method in which WBMB exposes a Bluetooth headset interface and smart phone or laptop that can sense, over Bluetooth Classic music, to be played in the WBMB inner speaker or on its attached multimedia channels.

Another embodiment of the invention is its method in which WBMB exposes a Wi-Fi music capabilities in a way that devices as Apple AirPlay can sense that and send music to be played in the WBMB inner speaker or on its attached multimedia channels.

Another embodiment of the invention is its method in which WBMB can sense nearby devices, as User smart phones, or User Bluetooth Smart key for verifying their authentication on the internet data base server or locally, inside the WBMB and send command to other Bluetooth Smart devices. For example Home Bluetooth Smart electronic door. Home Bluetooth Smart electronic door wirelessly connected to WBMB gets command to be open when user is near the door. This overcomes a problem where a Bluetooth Smart device can securely be paired only with one device, thereof to open the door for many users, as home family members. The electronic door pair with one WBMB device. The WBMB can detect many family members smart phones or Bluetooth Smart keyfob and open the same door.

Another embodiment of the invention is its method in which WBMB can send an IR remote control command.

Another embodiment of the invention is its method which WBMB can sense that there are no nearby devices as family members smart phones, or Users Bluetooth Smart keyfob and send this events to internet data base server.

The Internet data base server can command the WBMB to send a command to all Bluetooth Smart devices to move to no user state.
“No user state” can be: door moves to lock state. Electronic power to appliance is automatically closed. Light controlled by Bluetooth Smart get commands to be closed. Heater or air condition command to be closed, using Bluetooth Smart device command or over WBMB (FIG. 13. 140) IR channel. Bluetooth Smart alarm switched to “arm” state.
All Bluetooth Smart device in the range of WBMB (FIG. 13. 140) as Smoke and fire moved to alert user over their remote smart phone internet connection (FIG. 13. 148) etc.

Another embodiment of the invention is its method in which WBMB can send to internet speech recognition the user voice command, using its inner microphone. The recognized command is sent to internet data base server. The internet data base server sends a command to WBMB to activate the relevant Bluetooth Smart device. For example: a command to change channel on television or command to light the Bluetooth Smart device light bulb.

Another embodiment of the invention is its method in which WBMB can sense the proximity of the user near it by its proximity sensor and play a voice menu to be selected by the user.

Another embodiment of the invention is its method in which WBMB can sense user smart phone RSSI as the proximity of the user near itself and play a voice menu to be selected by the user.

Another embodiment of the invention is its method in which WBMB can send audio out over its audio output port, to external audio amplifier. Or connect to external microphones.

Another embodiment of the invention is its method in which WBMB exposes Wi-Fi Router capabilities and Wi-Fi Station capabilities in the same time. This allows many WBMB devices to be chained to other WBMB devices, to extend the coverage area monitoring of Bluetooth Smart devices. WBMB Station channel can connect to second WBMB Router channel. The second WBMB Station channel connects to third WBMB Router channel and so on. Until the last WBMB is connected to the internet. The mesh network is configure by Internet data base server (FIG. 13. 160).

Another embodiment of the invention is its method in which WBMB has the ability to retrieve content based on the Wi-Fi Mac address and the event sent out. The content can be commanded to WBMB device, or commands to be sent to wireless devices in the range of WBMB device. Wireless devices can be any Bluetooth Classic, Bluetooth Smart, Bluetooth smart ready or other formats of any wireless devices.

While the described embodiments relate to a Bluetooth Smart sensor, the same principles and features could be equally applied to host cell phone, PCs and host media systems.

Since WBMB has multimedia capabilities as inner speaker and Microphone. One of its functions is its ability to retrieve multimedia contents, as sound and play it using its inner speaker. Or retrieve, using its inner Microphone, a human voice and stream it to internet to be speech recognition. The recognized speech recognition can be used to command wireless devices connected to WBMB device.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A multimedia communication bridge that comprises:
a long range communication transceiver;
a short range communication transceiver;
a multimedia unit that comprises a speaker and a microphone; and
a controller;
wherein the long range communication transceiver is configured to communicate, using a first communication protocol, with a remote server the Internet;
wherein the short range communication transceiver is configured to communicate, using a second communication protocol, with multiple local devices;
wherein the multimedia communication bridge is configured to receive a message from one of the local devices;
wherein the controller is configured to generate a message response request to receive instructions for responding to the message;
wherein the long range communication transceiver is configured to transmit the message response request to the remote server and to receive the instructions;
wherein the controller is configured to execute the instructions and to respond to the message.

2. The multimedia communication bridge according to claim 1 wherein the message is a voice command received by the microphone; wherein the instructions comprises a textual representation of the voice command.

3. The multimedia communication bridge according to claim 2 wherein the controller is configured to generate, in response to the textual representation of the voice command, a media file retrieval request for retrieving a media file to be played by the multimedia communication bridge; wherein the long range communication transceiver is configured to transmit the media file retrieval request to the remote server and to receive the media file; wherein the multimedia unit is configured to play the media file.

4. The multimedia communication bridge according to claim 1 wherein the controller is configured to detect, based upon information provided by the short range transceiver, that a user device is proximate to the multimedia communication bridge; and wherein the controller is configured to generate a proximity response request to receive instructions for responding to the proximity of the user device; wherein the long range communication transceiver is configured to transmit the proximity response request to the remote server and to receive the instructions;
wherein the controller is configured to execute the instructions and to respond to the message.

5. The multimedia communication bridge according to claim 1 further comprising a proximity sensor; wherein the controller is configured to receive from the proximity sensor an indication that a user is proximate to the multimedia communication bridge; and wherein the controller is configured to generate a proximity response request to receive instructions for responding to the proximity of the user device; wherein the long range communication transceiver is configured to transmit the proximity response request to the remote server and to receive the instructions; wherein the controller is configured to execute the instructions and to respond to the message.

6. The multimedia communication bridge according to claim 1 wherein the first communication protocol is Wi-Fi.

7. The multimedia communication bridge according to claim 1 wherein the second communication protocol is Bluetooth or smart Bluetooth.

8. The multimedia communication bridge according to claim 1 further comprising a set of proximity buttons for receiving instructions from a user.

9. The multimedia communication bridge according to claim 1 further comprising a set of communication ports for interfacing with at least one local device via a cable.

10. The multimedia communication bridge according to claim 1 further comprising an infrared remote control unit; wherein the infrared remote control unit is configured to receive an infrared command; wherein the controller is configured to generate an infrared command response request to receive instructions for responding to the infrared command; wherein the long range communication transceiver is configured to transmit the infrared command response request to the remote server and to receive the instructions; wherein the controller is configured to execute the instructions and to respond and generate infrared command.

11. The multimedia communication bridge according to claim 1 comprising:
a case that that has a cover that contacts the speaker without concealing the speaker;
a top panel that encloses the controller, the long range transceiver and the short range transceiver;
wherein the case is connected to the top panel by multiple legs;
wherein the speaker faces the top panel.

12. The multimedia communication bridge according to claim 11 wherein the top panel supports a set of proximity buttons.

13. The multimedia communication bridge according to claim 11 further comprising a reset button, at least one multiple universal serial bus (USB) ports, a power port, at least one non-USB communication port, a microphone input port and an auxiliary audio port.

14. The multimedia communication bridge according to claim 11 further comprising an infrared remote control unit.

15. The multimedia communication bridge according to claim 11 further comprising a proximity sensor.

16. The multimedia communication bridge according to claim 1, wherein the multimedia communication bridge is portable.

17. A multimedia communication bridge that comprises:
a long range communication transceiver;
a short range communication transceiver;
a multimedia unit that comprises a speaker and a microphone; and
a controller;
a case that that has a cover that contacts the speaker;
a top panel that encloses the controller, the long range transceiver and the short range transceiver;
wherein the speaker faces the top panel and is spaced apart from the tip panel.
wherein the long range communication transceiver is configured to communicate, using a first communication protocol, with a remote server the Internet;
wherein the short range communication transceiver is configured to communicate, using a second communication protocol, with multiple local devices;

18. The multimedia communication bridge according to claim 17 wherein the top panel supports a set of proximity buttons.

19. The multimedia communication bridge according to claim 17 further comprising a reset button, at least one multiple universal serial bus (USB) ports, a power port, at least one non-USB communication port, a microphone input port and an auxiliary audio port.

20. The multimedia communication bridge according to claim 17 further comprising an infrared remote control unit.

21. The multimedia communication bridge according to claim 17 further comprising a proximity sensor.

22. The multimedia communication bridge according to claim 1 wherein the first communication protocol is Wi-Fi.

23. The multimedia communication bridge according to claim 1 wherein the second communication protocol is Bluetooth or smart Bluetooth.

24. The multimedia communication bridge according to claim 1 further comprising a set of proximity buttons for receiving instructions from a user.
